(19) United States
(12) Patent Application Publication
(10) Pub. No.: US 2018/0141775 A1
(43) Pub. Date: May 24, 2018

(54) PAPER POSTPROCESSING APPARATUS

(71) Applicant: Gradco Japan Ltd., Shinagawa-ku, Tokyo (JP)

(72) Inventor: Kenichi WATANABE, Shinagawa-ku, Tokyo (JP)

(21) Appl. No.: 15/575,122

(22) PCT Filed: May 26, 2016
(86) PCT No.: PCT/JP2016/065608

§ 371 Date: Nov. 17, 2017

(30) Foreign Application Priority Data
Jun. 11, 2015 (JP) 2015-118727
Jun. 11, 2015 (JP) 2015-118728

(51) Int. Cl. B65H 29/24; B65H 29/66; B65H 31/26; B65H 31/30; B65H 31/34; G03G 15/00

(52) U.S. Cl. CPC B65H 29/246; B65H 29/6618; B65H 31/26; B65H 31/3027; B65H 2701/1313; G03G 15/5054; B65H 2301/4213; B65H 2406/3122; B65H 31/34

(57) ABSTRACT

A buffer means includes a buffer unit that makes paper sheets temporarily stand by and a paper stacking unit that intermittently conveys paper sheets and sucks the trailing edges of the paper sheets to stack the paper sheets stepwise and make them temporarily stand by.

### BACKGROUND

### Technical Field

The present invention relates to a paper postprocessing apparatus as peripheral equipment of an image forming apparatus such as a printer, copying machine, or printing machine.

### Related Art

A paper postprocessing apparatus is detachably mounted on an image forming apparatus such as a copying machine, printer, or multifunction printer. For example, with advances in online technology, copying machines and printers have been widely used, which form images on paper sheets on the basis of image data sent from host computers such as personal computers via communication lines such as a LAN, and apply postprocessing such as stapling, punching, and creasing to the paper sheets on which the images are formed (JP 10-120284 A).

Some of these paper postprocessing apparatuses include buffer apparatuses each configured to stack paper sheets stepwise on a paper transport path, with the leading edges of the paper sheets being arranged at predetermined intervals, and deliver the paper sheets. For example, a buffer apparatus includes a binder for binding paper sheets delivered from an image forming apparatus, a complier for making stacked sheets stand by until binding processing, a paper transport path for transporting paper sheets to the complier and the like, and a stacker on which bound paper sheets delivered outside are stacked.

### SUMMARY

In such a general buffer apparatus, paper sheets are stacked stepwise on a paper transport path, with the leading edges of the paper sheets being arranged at predetermined intervals, but it is difficult to accurately stack paper sheets stepwise. In addition, paper sheets stacked stepwise sometimes shift from each other. As described above, paper sheets stacked stepwise are sometimes delivered from the buffer apparatus while being shifted from each other, and hence it is difficult to accurately bind a bundle of paper sheets.

The problem to be solved by the present invention is to provide, in consideration of the above situation, a paper postprocessing apparatus that can accurately buffer a predetermined number of paper sheets on a paper transport path without any shift between them and quickly deliver the buffered paper sheets, thereby improving processing ability.

In order to solve the above problem and achieve the object, the present invention has the following arrangement.

The invention according to a first aspect is a paper postprocessing apparatus including:

a paper convey unit configured to convey a paper sheet delivered by an image forming apparatus;

buffer means configured to make a paper sheet to be conveyed temporarily stand by; and

a jogger/stack unit having a pair of left and right joggers and configured to support paper sheets delivered by the buffer means and stack the paper sheets while aligning the paper sheets in a paper widthwise direction,

wherein the buffer means includes:
a buffer unit configured to make a paper sheet temporarily stand by; and
a paper stacking unit configured to intermittently convey paper sheets and suck trailing edges of the paper sheets to stack the paper sheets stepwise and make the paper sheets temporarily stand by.

The invention according to a second aspect is the paper postprocessing apparatus according to the first aspect, wherein the paper stacking unit includes a loading unit configured to load a paper sheet into the buffer unit and an unloading roller pair configured to unload a paper sheet made to temporarily stand by stepwise to the jogger/stack unit,

the unloading roller pair is configured to nip and separate from each other, and

when stacking paper sheets stepwise and making the paper sheets temporarily stand by,

repeats nipping a paper sheet and intermittently conveying by using the unloading roller pair and sucking a trailing edge of the paper sheet at a timing when the trailing edge of the paper sheet is loaded from the loading unit into the buffer unit,

separating the unloading roller pair from each other at a timing when a leading edge of a next paper sheet to be conveyed approaches the unloading roller pair, and

causing the unloading roller pair to nip and intermittently convey the next paper sheet and sucking a trailing edge of the paper sheet at a timing when the trailing edge of the next paper sheet is loaded from the loading unit into the buffer unit.

The invention according to a third aspect is the paper postprocessing apparatus according to the first aspect further including alignment means configured to align paper sheets delivered by the paper convey unit in the paper convey direction,

wherein the alignment means includes:

a small-size alignment unit configured to align a bundle of small-size paper sheets by pulling back the bundle of paper sheets conveyed stepwise in the paper convey direction so as to bring leading edges of the bundle of paper sheets into contact with the small-size alignment unit; and

a large-size alignment unit configured to align large-size paper sheets by pulling back the large-size paper sheets, conveyed one by one, in the convey direction one by one.

The invention according to a fourth aspect is the paper postprocessing apparatus according to third aspect, wherein the small-size alignment unit includes a stopper with which leading edges of a bundle of paper sheets come into contact,

makes the stopper stand by at a position where leading edges of the bundle of paper sheets come into contact with the stopper, holds the bundle of paper sheets to be conveyed, aligns the paper sheets in a widthwise direction of a paper sheet by using the pair of left and right joggers, and

adjusts the bundle of paper sheets at a reference position by pulling back the bundle of paper sheets in the paper convey direction by using the stopper.

The invention according to a fifth aspect is the paper postprocessing apparatus according to the third aspect, wherein the large-size alignment unit includes a roller configured to pull back a paper sheet in the convey direction,

makes the roller stand by at a position where the roller is able to convey a large-size paper sheet,

pulls back large-size paper sheets to be conveyed to a reference position one by one by rotating the roller, and

causes the pair of left and right joggers to align the paper sheets in a widthwise direction and adjust the paper sheets at the reference position.

The invention according to a sixth aspect is the paper postprocessing apparatus according to the third aspect, wherein the alignment means is provided with the stopper and the roller on an operating shaft disposed in a widthwise direction of a paper sheet and movable in the paper convey direction,

when aligning the small-size paper sheets,

makes the stopper stand by at a position where leading edges of the bundle of paper sheets come into contact with the stopper, to hold the bundle of paper sheets to be conveyed, and causes the pair of left and right joggers to align the paper sheets in the widthwise direction,

moves the operating shaft in the paper convey direction to cause the stopper to pull back the bundle of paper sheets in the paper convey direction and adjust the paper sheets at the reference position, and

when aligning the large-size paper sheets,

rotates the operating shaft to make the roller stand by at a position where the roller is able to convey a large-size paper sheet,

rotates the operating shaft to move the roller from a standby position to an operation position so as to pull back large-size paper sheets to be conveyed to the reference position one by one by rotating the roller, and

causes the pair of left and right joggers to align the paper sheets in the widthwise direction and adjust the paper sheets at the reference position.

With the above arrangement, the present invention has the following effects.

In the invention according to claims 1 and 2, the buffer means includes the buffer unit that makes each paper sheet temporarily stand by and the paper stacking unit that intermittently conveys each paper sheet and sucks the trailing edge of the paper sheet so as to stack paper sheets stepwise and make them temporarily stand by. The buffer means can accurately buffer a predetermined number of paper sheets on the paper transport path without shifting them from each other by intermittently conveying paper sheets and sucking the trailing edges of the paper sheets so as to stack them stepwise and make them temporarily stand by, and quickly deliver the buffered paper sheets, thereby improving processing ability.

The invention according to claims 3 and 6 includes the small-size alignment unit that pulls back a bundle of small-size paper sheets in the paper convey direction and aligns them so as to bring the leading edges of the bundle of small-size paper sheets conveyed stepwise into contact with the small-size alignment unit and the large-size alignment unit that pulls back large-size paper sheets, conveyed one by one, in the convey direction one by one and aligns them, and hence can stack even a bundle of paper sheets having different sizes without shifting them from each other. This makes it possible to improve the stackability of a bundle of paper sheets and shorten the time taken to receive paper sheets to improve productivity.

### BRIEF DESCRIPTION OF DRAWINGS

FIG. 1 is a view showing how a paper postprocessing apparatus is coupled to an image forming apparatus such as a copying machine;

FIG. 2 is a perspective view of the paper postprocessing apparatus;

FIG. 3 is a schematic view of a buffer unit;

FIGS. 4A to 4F are views showing the operation of a buffer means;

FIG. 5 is a view showing the arrangement of alignment means;

FIG. 6 is a schematic perspective view of an alignment unit;

FIGS. 7A to 7C are views showing the operation of a small-size alignment unit; and

FIGS. 8A to 8C are views showing the operation of a large-size alignment unit.

### DETAILED DESCRIPTION

A paper postprocessing apparatus according to an embodiment of the present invention will be described below. This embodiment of the present invention is the best mode for carrying out the invention. However, the present invention is not limited to this embodiment.

### (Arrangement of Paper Postprocessing Apparatus)

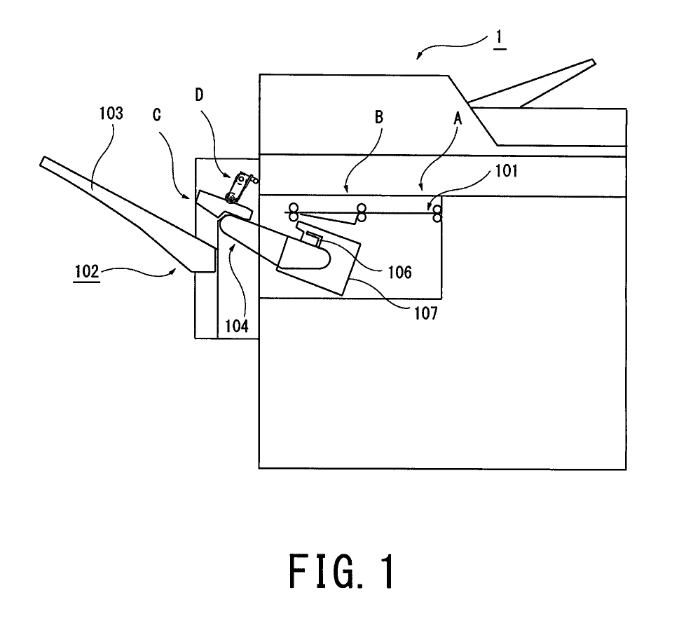

FIG. 1 shows how a paper postprocessing apparatus is coupled to an image forming apparatus such as a copying machine. A paper postprocessing apparatus 102 is detachably mounted on an image forming apparatus 1 such as a copying machine, printer, or multifunction printer. The paper postprocessing apparatus 102 includes a convey unit 101 that conveys paper sheets, a compile unit 104, and a stacker tray 103 disposed below the compile unit 104. The convey unit 101 includes a paper convey unit A that conveys paper sheets delivered by the image forming apparatus 1 and a buffer means B that makes paper sheets to be conveyed stand by. The paper convey unit A includes rollers. When paper sheets are transported from the image forming apparatus 1, the transported paper sheets are stacked in the compile unit 104 through the rollers. A stapler 107 postprocesses the paper sheets. The postprocessed bundle of paper sheets are delivered onto the stacker tray 103.

The compile unit 104 is constituted by a jogger/stack unit C, an ejector 106, and the like. The jogger/stack unit C supports paper sheets to be conveyed and stacks them, with the paper sheets being aligned in the widthwise direction. Additional devices such as the stapler 107 capable of postprocessing a bundle of paper sheets stacked on the compile unit 104 are installed at the lower end portion of the compile unit 104. Alignment means D is disposed on the upper side of the compile unit 104 to align paper sheets delivered by the paper convey unit A in the convey direction.

### (Arrangements of Buffer Means, Jogger/Stack Unit, and Alignment Means)

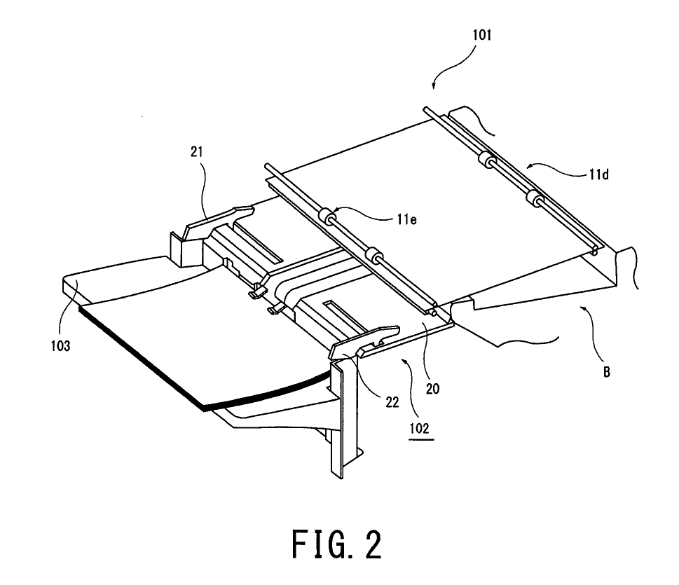

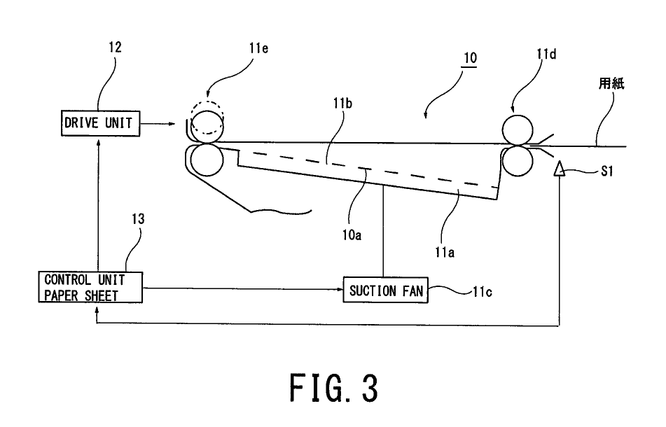

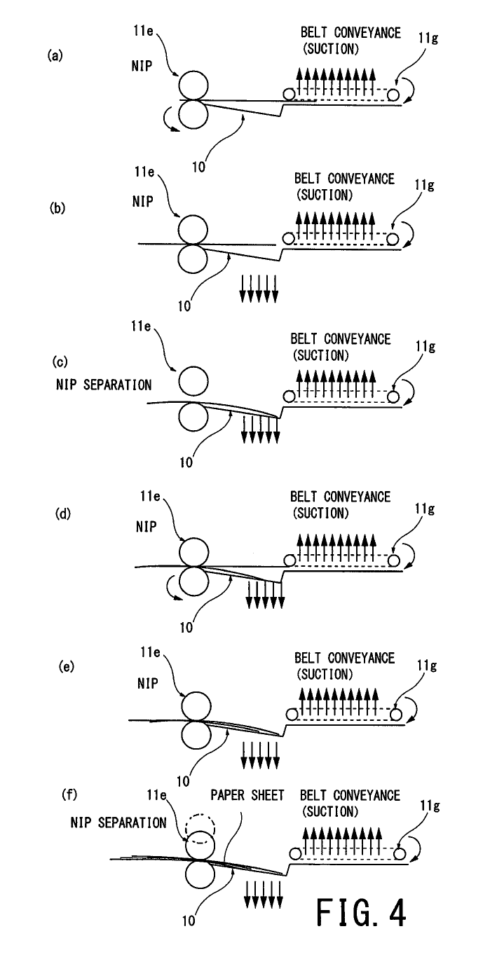

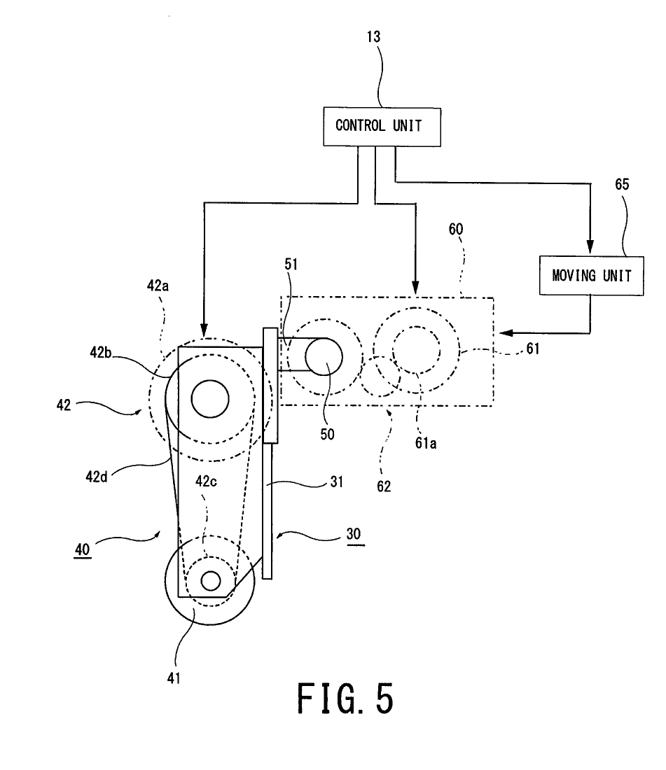

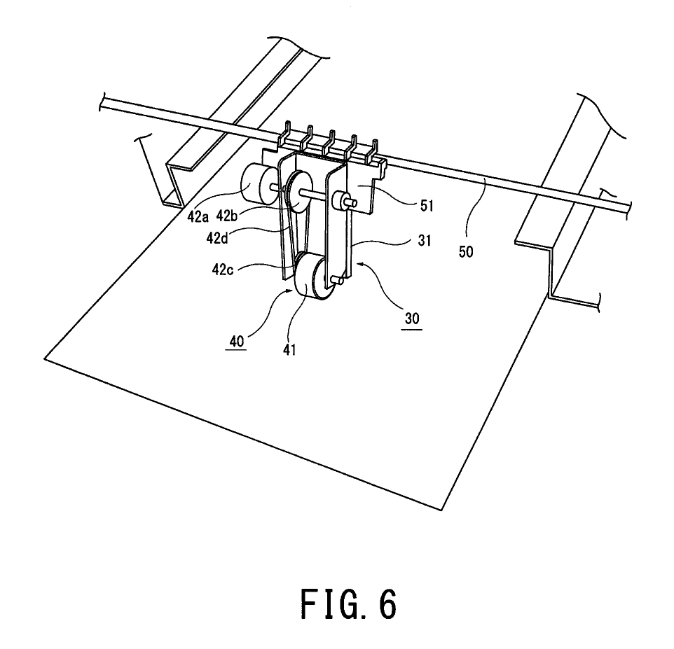

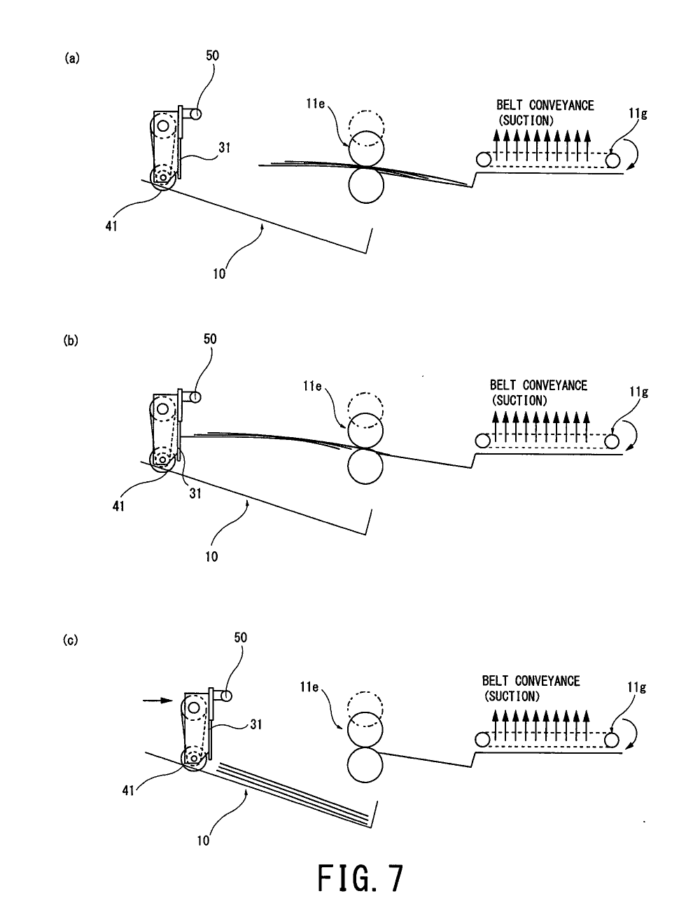

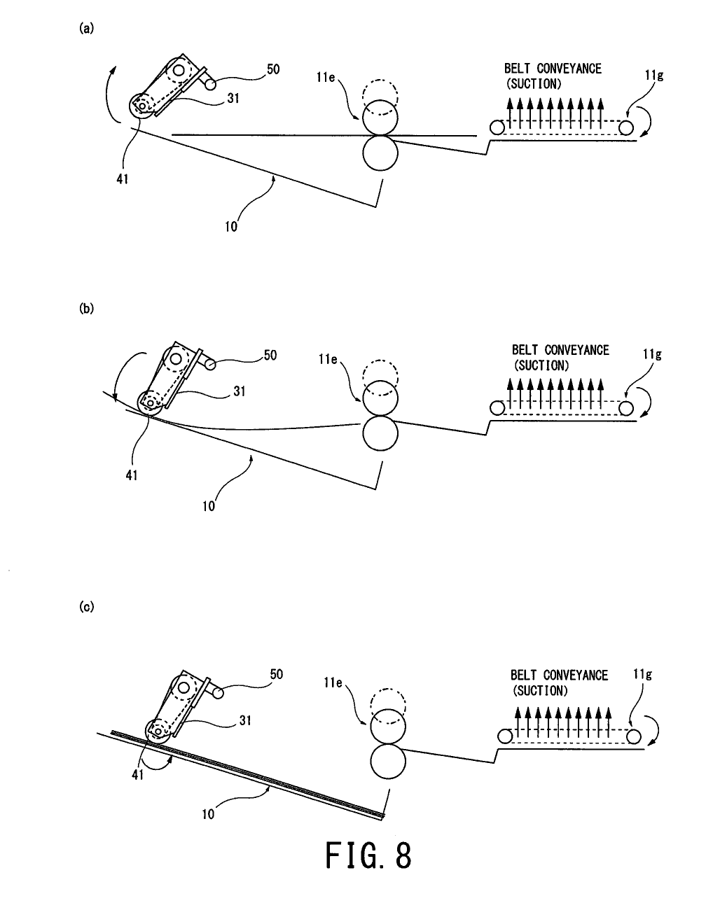

FIG. 2 is a perspective view of the paper postprocessing apparatus. FIG. 3 is a schematic view of the buffer unit. FIGS. 4A to 4F show the operation of the buffer means. FIG. 5 shows the arrangement of the alignment means. FIG. 6 is a perspective view of the alignment unit. FIGS. 7A to 7C show the operation of a small-size alignment unit. FIGS. 8A to 8C show the operation of a large-size alignment unit. In a paper postprocessing apparatus 102, the buffer means B, the jogger/stack unit C, and the alignment means D are arranged along a paper convey path of the convey unit 101.

### [Arrangement Buffer Means]

The buffer means B is configured to make paper sheets to be conveyed temporarily stand by, and includes a buffer unit 10 that makes paper sheets temporarily stand by and a paper stacking unit 11 that intermittently conveys paper sheets and sucks the trailing edges of the paper sheets to stack the paper sheets stepwise and make them temporarily stand by.

The buffer unit 10 is structured to have a bottom portion 10a inclined downward in the paper convey direction, and can make paper sheets to be conveyed to the bottom portion 10a temporarily stand by. The paper stacking unit 11 includes a suction room 11a formed in a lower portion of the bottom portion 10a of the buffer unit 10, suction holes 11b formed in the bottom portion 10a so as to communicate with the suction room 11a, and a suction fan 11c communicating with the suction room 11a. The suction fan 11c is driven to depressurize the suction room 11a so as to suck paper sheets temporarily standing by on the bottom portion 10a of the buffer unit 10 via the suction holes 11b, thereby reliably holding the paper sheets temporarily standing by while preventing them from shifting.

The paper stacking unit 11 also includes a loading roller pair 11d as a loading unit that loads paper sheets into the buffer unit 10 and a loading detection sensor S1 arranged on the loading side of the buffer unit 10 and an unloading roller pair 11e arranged on the loading side of the buffer unit 10.

The unloading roller pair 11e is configured by a drive unit 12 to nip and separate. A control unit 13 controls the drive unit 12 on the basis of the paper detection information obtained by the loading detection sensor S1, and controls the suction fan 11c.

The control unit 13 performs control to cause the loading detection sensor S1 to detect a conveyed paper sheet, when paper sheets are stacked stepwise and made to stand by, and send the paper detection information to the control unit 13. The control unit 13 controls the drive unit 12 on the basis of the paper detection information to drive the suction fan 11c to depressurize the suction room 11a at the timing when a paper sheet is nipped and intermittently conveyed by the unloading roller pair 11e and the trailing edge of the paper sheet is loaded from the loading roller pair 11d into the buffer unit 10, thereby sucking the trailing edge of the paper sheet via the suction holes 11b. The control unit 13 then separates the unloading roller pair 11e at the timing when the leading edge of paper sheet conveyed next approaches the unloading roller pair 11e, and nips and intermittently conveys the paper sheet by using the unloading roller pair 11e and sucks the trailing edge of the paper sheet at the timing when the trailing edge of the next paper sheet is loaded from the loading roller pair 11d into the buffer unit 10. The control unit 13 repeats this operation. In the buffer means B, conveyed paper sheets are stacked stepwise and made to temporarily stand by. When a predetermined number of paper sheets are stacked, the control unit 13 drives the unloading roller pair 11e to deliver the paper sheets stacked stepwise to the jogger/stack unit C.

### [Operation of Buffer Means]

The operation of the buffer means B will be described next with reference to FIGS. 4A to 4F. In this embodiment, the loading unit that loads paper sheets into the buffer unit 10 uses a loading belt 11g in place of the loading roller pair 11d.

The first paper sheet is sucked and conveyed by the loading belt 11g and nipped and conveyed by the unloading roller pair 11e (FIG. 4A). The control unit 13 stops driving the unloading roller pair 11e and drives the suction fan 11c to start sucking the trailing edge of the paper sheet at the timing when the trailing edge of the paper sheet separates from the loading belt 11g and the paper sheet is loaded into the buffer unit 10 (FIG. 4B).

The control unit 13 then separates the unloading roller pair 11e at the timing when the leading edge of the paper sheet approaches the unloading roller pair 11e (FIG. 4C).

At the timing when the next paper sheet is sucked and conveyed by the loading belt 11g and the trailing edge of the next paper sheet passes through the loading belt 11g, the control unit 13 intermittently drives the unloading roller pair 11e to nip and convey the next paper sheet so as to slightly shift it from the previous paper sheet, thereby providing a suction margin for the trailing edge of the next paper sheet (FIG. 4D).

The control unit 13 then stops driving the unloading roller pair 11e and causes the suction fan 11c to suck the trailing edge of the next paper sheet at the timing when the trailing edge of the next paper sheet separates from the loading belt 11g and the paper sheet is loaded into the buffer unit 10 (FIG. 4E).

Subsequently, the control unit 13 repeats the operations in FIGS. 4C, 4D, and 4E to stack two or more paper sheets stepwise and make them temporarily stand by (FIG. 4F).

### [Arrangement of Jogger/Stack Unit]

The jogger/stack unit C is configured to support the paper sheets delivered by the buffer means B and stack the paper sheets while aligning them in the widthwise direction, and includes a base tray 20 where the paper sheets are stacked and a pair of joggers 21 and 22. More specifically, of the pair of joggers 21 and 22, the selected jogger 22 on one side functions as a fixed jogger, and the jogger 21 on the other side functions as a drive jogger. The drive jogger 21 is configured to enable interval adjustment in a direction perpendicular to the direction in which paper sheets are transported.

The buffer means B makes conveyed paper sheets temporarily stand by. A predetermined number of paper sheets are then loaded from the buffer means B into the base tray 20. The drive jogger 21 simultaneously pushes side surfaces of the stacked paper sheets and shifts them to the fixed jogger 22 to adjust them. Alternatively, paper sheets are loaded onto the base tray 20 one by one without causing the buffer means B to make them temporarily stand by, and the drive jogger 21 pushes a side surface of a paper sheet and shifts it to the fixed jogger 22 to adjust it every time a paper sheet is transported onto the base tray 20.

### [Arrangement of Alignment Means]

The alignment means D is configured to align paper sheets delivered to the jogger/stack unit C by the paper convey unit A in the convey direction, and includes a small-size alignment unit 30 and a large-size alignment unit 40.

The small-size alignment unit 30 is configured to pull back a bundle of small-size paper sheets conveyed stepwise in the paper convey direction so as to bring the leading edges of the bundle of paper sheets into contact with the small-size alignment unit 30, and includes a stopper 31 with which the leading edges of the bundle of paper sheets come into contact. The stopper 31 is fixed to a holding unit 51 fixed to an operating shaft 50.

The large-size alignment unit 40 is configured to pull back large-size paper sheets, conveyed one by one, in the convey direction one by one so as to align each paper sheet, and includes a roller 41 configured to pull back a paper sheet in the convey direction. The roller 41 is provided on the holding unit 51 fixed to the operating shaft 50 so as to be pivotal by means of a drive mechanism 42. The drive mechanism 42 includes a drive motor 42a, a drive pulley 42b, a driven pulley 42c, and a belt 42d. The drive motor 42a rotates the drive pulley 42b so as to transfer the rotating force to the driven pulley 42c via the belt 42d, thereby rotating the roller 41.

The operating shaft 50 is pivotally provided on a pair of mobile bodies 60 arranged on two sides of the base tray 20. One mobile body 60 is provided with a drive motor 61. An output gear 61a of the drive motor 61 meshes with a drive gear 50a of the operating shaft 50 via a gear mechanism 62. When the drive motor 61 is driven, the operating shaft 50 rotates via the gear mechanism 62. The pair of mobile bodies 60 are configured to move paper sheets in the convey direction by means of a moving unit 65. As the moving unit 65, a cylinder mechanism, solenoid mechanism, or the like is used.

The control unit 13 drives the drive motor 42a, the drive motor 61, and the moving unit 65. The alignment means D is disposed in the widthwise direction of a paper sheet. The stopper 31 and the roller 41 are provided to the operating shaft 50 capable of moving in the paper convey direction. The small-size alignment unit 30 pulls back paper sheets in the paper convey direction to bring the leading edges of a bundle of small-size paper sheets conveyed stepwise into contact with the stopper 31, thereby aligning the paper sheets. The large-size alignment unit 40 causes the roller 41 to pull back large-size paper sheets, conveyed one by one, in the convey direction one by one, thereby aligning each paper sheet.

As described above, the small-size alignment unit 30 includes the stopper 31 with which the leading edge of each of a bundle of paper sheets comes into contact. When aligning small-size paper sheets, the small-size alignment unit 30 makes the stopper 31 stand by at a position where the leading edges of the bundle of paper sheets come into contact with the stopper 31, holds the conveyed bundle of paper sheets, and aligns the bundle of paper sheets in the widthwise direction via the pair of left and right joggers 21 and 22. The moving unit 65 moves the pair of mobile bodies 60. The small-size alignment unit 30 moves the stopper 31 held on the operating shaft 50 via the holding unit 51 so as to cause the stopper 31 to pull back the bundle of paper sheets in the paper convey direction, thereby adjusting the bundle of paper sheets at a reference position.

In addition, the large-size alignment unit 40 includes the roller 41 configured to pull back each paper sheet in the convey direction. When aligning each large-size paper sheet, the large-size alignment unit 40 rotates the operating shaft 50 to make the roller 41 stand by at a position where it can convey each large-size paper sheet. The large-size alignment unit 40 rotates the operating shaft 50 to move the roller 41 from the standby position to an operation position, and rotates the roller 41 to pull back large-size paper sheets one by one to the reference position. The large-size alignment unit 40 then aligns each paper sheet in the widthwise direction and adjusts each paper sheet at the reference position by using the pair of left and right joggers 21 and 22.

### [Operation of Alignment Means]

As shown in FIGS. 7A to 7C, the small-size alignment unit 30 includes the stopper 31 with which the leading edges of a bundle of paper sheets delivered by the buffer means B come into contact. When aligning small-size paper sheets, the small-size alignment unit 30 makes the stopper 31 stand by at a position where the leading edges of the bundle of paper sheets come into contact with the stopper 31 (FIG. 7A). The leading edges of the bundle of paper sheets come into contact with the stopper 31. The stopper 31 holds the conveyed bundle of paper sheets. The small-size alignment unit 30 then aligns the paper sheets in the widthwise direction by using the pair of left and right joggers 21 and 22 (FIG. 7B), and moves the operating shaft 50 in the paper convey direction to cause the stopper 31 to pull back the bundle of paper sheets in the paper convey direction, thereby adjusting the paper sheets at the reference position (FIG. 7C).

As shown in FIGS. 8A to 8C, the large-size alignment unit 40 includes the roller 41 configured to pull back each paper sheet in the convey direction. When aligning each large-size paper sheet, the large-size alignment unit 40 rotates the operating shaft 50 to make the roller 41 stand by at a position where it can convey each large-size paper sheet (FIG. 8A). The large-size alignment unit 40 rotates the operating shaft 50 to rotate the roller 41 from the standby position to the operation position at the timing when one paper sheet is delivered to a position below the roller 41 (FIG. 8B), and rotates the roller 41 at the operation position to pull back the conveyed large-size paper sheet to the reference position. The large-size alignment unit 40 then rotates the operating shaft 50 to make the roller 41 stand by at a position where it can convey the large-size paper sheet. Likewise, the large-size alignment unit 40 rotates the roller 41 to pull back conveyed large-size paper sheets one by one to the reference position, aligns each paper sheet in the widthwise direction and adjusts it at the reference position by using the pair of left and right joggers 21 and 22 (8C).

The present invention can be applied to a paper postprocessing apparatus connected to an image forming apparatus such as a copying machine or printer, allows even paper sheets having different sizes to be stacked without any shift. The present invention can therefore improve the stackability of a bundle of paper sheets and productivity by shortening the time taken to receive paper sheets.

What is claimed is:

1. A paper postprocessing apparatus comprising:
a paper convey unit configured to convey a paper sheet delivered by an image forming apparatus;
buffer means configured to make a paper sheet to be conveyed temporarily stand by; and
a jogger/stack unit having a pair of left and right joggers and configured to support paper sheets delivered by the buffer means and stack the paper sheets while aligning the paper sheets in a paper widthwise direction,
wherein the buffer means includes:
a buffer unit configured to make a paper sheet temporarily stand by; and
a paper stacking unit configured to intermittently convey paper sheets and suck trailing edges of the paper sheets to stack the paper sheets stepwise and make the paper sheets temporarily stand by.

2. The paper postprocessing apparatus according to claim 1, wherein the paper stacking unit includes a loading unit configured to load a paper sheet into the buffer unit and an unloading roller pair configured to unload a paper sheet made to temporarily stand by stepwise to the jogger/stack unit,
the unloading roller pair is configured to nip and separate from each other, and
when stacking paper sheets stepwise and making the paper sheets temporarily stand by,
repeats nipping a paper sheet and intermittently conveying by using the unloading roller pair and sucking a trailing edge of the paper sheet at a timing when the trailing edge of the paper sheet is loaded from the loading unit into the buffer unit,
separating the unloading roller pair from each other at a timing when a leading edge of a next paper sheet to be conveyed approaches the unloading roller pair, and
causing the unloading roller pair to nip and intermittently convey the next paper sheet and sucking a trailing edge of the paper sheet at a timing when the trailing edge of the next paper sheet is loaded from the loading unit into the buffer unit.

3. The paper postprocessing apparatus according to claim 1, further comprising alignment means configured to align paper sheets delivered by the paper convey unit in the paper convey direction,
wherein the alignment means includes:
a small-size alignment unit configured to align a bundle of small-size paper sheets by pulling back the bundle of paper sheets conveyed stepwise in the paper convey direction so as to bring leading edges of the bundle of paper sheets into contact with the small-size alignment unit; and
a large-size alignment unit configured to align large-size paper sheets by pulling back the large-size paper sheets, conveyed one by one, in the convey direction one by one.

4. The paper postprocessing apparatus according to claim 3, wherein the small-size alignment unit includes a stopper with which leading edges of a bundle of paper sheets come into contact,
makes the stopper stand by at a position where leading edges of the bundle of paper sheets come into contact with the stopper, holds the bundle of paper sheets to be conveyed, aligns the paper sheets in a widthwise direction of a paper sheet by using the pair of left and right joggers, and
adjusts the bundle of paper sheets at a reference position by pulling back the bundle of paper sheets in the paper convey direction by using the stopper.

5. The paper postprocessing apparatus according to claim 3, wherein the large-size alignment unit includes a roller configured to pull back a paper sheet in the convey direction,
makes the roller stand by at a position where the roller is able to convey a large-size paper sheet,
pulls back large-size paper sheets to be conveyed to a reference position one by one by rotating the roller, and
causes the pair of left and right joggers to align the paper sheets in a widthwise direction and adjust the paper sheets at the reference position.

6. The paper postprocessing apparatus according to claim 3, wherein the alignment means is provided with the stopper and the roller on an operating shaft disposed in a widthwise direction of a paper sheet and movable in the paper convey direction,
when aligning the small-size paper sheets,
makes the stopper stand by at a position where leading edges of the bundle of paper sheets come into contact with the stopper, to hold the bundle of paper sheets to be conveyed, and causes the pair of left and right joggers to align the paper sheets in the widthwise direction,
moves the operating shaft in the paper convey direction to cause the stopper to pull back the bundle of paper sheets in the paper convey direction and adjust the paper sheets at the reference position, and
when aligning the large-size paper sheets,
rotates the operating shaft to make the roller stand by at a position where the roller is able to convey a large-size paper sheet,
rotates the operating shaft to move the roller from a standby position to an operation position so as to pull back large-size paper sheets to be conveyed to the reference position one by one by rotating the roller, and
causes the pair of left and right joggers to align the paper sheets in the widthwise direction and adjust the paper sheets at the reference position.
